(19) United States
(12) Patent Application Publication
(10) Pub. No.: US 2016/0078088 A1
(43) Pub. Date: Mar. 17, 2016

(54) Systems and Methods for Providing Metadata Aware Background Caching in Data Analysis

(71) Applicants: Rajat Venkatesh, Bangalore (IN); Amogh Margoor, Bangalore (IN); Pavan Srinivas Bysani, Bangalore (IN)

(72) Inventors: Rajat Venkatesh, Bangalore (IN); Amogh Margoor, Bangalore (IN); Pavan Srinivas Bysani, Bangalore (IN)

(21) Appl. No.: 14/854,708

(22) Filed: Sep. 15, 2015

Related U.S. Application Data
(60) Provisional application No. 62/050,299, filed on Sep. 15, 2014.

(51) Int. Cl. G06F 17/30; G06F 12/08

(52) U.S. Cl. CPC G06F 17/30457; G06F 12/0893; G06F 17/30377; G06F 2212/1016; G06F 2212/608

(57) ABSTRACT

In general, the present invention is directed to systems and corresponding methods for providing metadata aware background caching amongst various tables in data processing systems, the system configured to process either an original copy of data stored or data stored in derived tables in one or more data stores, the system including: a query optimization module, a catalog module, and a dataset manager. Each of the query optimization module, catalog module, and dataset manager may be communicatively connected to the original copy of data and the derived tables in one or more data stores. The query optimization module configured to conduct queries against data stored in the original copy of data or in the derived tables; the catalog module configured to register tables of data across various types and formats of data stores; and the dataset manager configured to maintain the freshness of the data in the derived tables.

### RELATED APPLICATIONS

The present application claims priority to U.S. Provisional Patent Application No. 62/050,299, filed Sep. 15, 2014, which is incorporated herein by reference in its entirety.

### BACKGROUND

It is common for organizations to maintain a data set in a number of formats. For example, one format of a certain dataset may be used to generate daily batch reports. A different format of the same certain dataset may be used by researchers for ad hoc analysis. Yet another format of the same certain dataset may be used in conjunction with streaming information in order to respond to user actions on a website or video game.

Because different formats are required, each dataset may be stored by different storing engines. It is generally time and resource consuming to convert the same dataset to different formats, maintain current datasets and changes thereto across all formats, and manage the lifecycle of all copies and formats. Moreover, there are no current systems that permit standardization of properties and options (such as metadata, bulk import/export mechanisms, etc.).

In data processing systems (such as SQL based systems), data from various tables may be queried and processed. Such data tables may be created by a user, and may be in any number of formats. However, a format used in an original data tables may not be the most efficient or desirable. Accordingly, it is desirable to provide systems and methods wherein a user may create derived tables, which may not have the same structure as the original or canonical table. The original table and/or one or more derived tables may then be used for queries and/or processing. For example, a derived table may not have the same columns or data types as the canonical table. A derived table may be a view with joins, projections, filters, ordering and other transformations, or be a cube that may store pre-aggregated data.

It is also desirable to provide systems and methods wherein a user may store derived tables in various and/or different locations than the canonical tables. For example, a canonical table may be stored in Oracle or Apache Hive, while a derived table may be stored, for example, in Amazon Web Services (AWS) Redshift, HP Vertica, MySQL, or Apache HBase.

In addition, various database systems—as well as online analytical processing (OLAP) systems may use dataset features such as indexes, views, and cubes. In such circumstances, a processing system may only use a derived dataset if it was stored in the same database instance as the canonical table. Accordingly, it is desirable to provide systems and methods where datasets—in various formats—may be stored in different database instances or technologies for queries and processing.

### SUMMARY OF THE INVENTION

Aspects in accordance with some embodiments of the present invention may include a system for providing metadata aware background caching amongst various tables in data processing systems, the system configured to process either an original copy of data stored in a first format or data stored in derived tables in one or more data stores, the system comprising: a query optimization module, the query optimization module communicatively connected to the original copy of data, the derived tables, and a catalog module, the query optimization module configured to conduct queries against data stored in the original copy of data or in the derived tables; a catalog module, communicatively connected to the original copy of the data and the derived tables, the catalog module in further communication with the query optimizer and a dataset manager, the catalog module configured to register tables of data across various types and formats of data stores; and a dataset manager, communicatively connected to the original copy of the data, the derived tables, and the catalog module, the dataset manager configured to maintain the freshness of the data in the derived tables.

Other aspects in accordance with some embodiments of the present invention may include a system for providing metadata aware background caching amongst various tables in data processing systems, the system configured to process either an original copy of data stored in a first format or data stored in derived tables in one or more data stores, the system comprising: a cache manager, configured to copy and move data amongst various data stores, the cache manager in selective communication with the original copy of data, one or more data stores in which derived tables are stored, and a policy manager module; a policy manager module in communication with the cache manager, the policy manager comprising lifecycle policies for the original copy of data and the one or more data stores; and one or more data stores, comprising derived tables that comprise data derived from the original copy of the data.

Other aspects in accordance with some embodiments of the present invention may include a system for providing metadata aware background caching amongst various tables in data processing systems, the system configured to process either an original copy of data stored in a first format or data stored in derived tables in one or more data stores, the system comprising: a query optimization module comprising a cost-based optimizer configured to determine a most desirable manner of conducting queries, and further configured to conduct queries against data stored in the original copy of data or in the derived tables; a catalog module configured to perform metadata reads of each of the original copy of the data and the derived tables, and further configured to register tables of data across various types and formats of data stores; a dataset manager configured to maintain the freshness of the data in the derived tables, the data set manager comprising: an event listener module, the event listener module configured to initiate a data manipulation language (DML) operation when prompted; a scheduler module, configured to regularly and/or periodically check if policies associated with the original copy of the data and the derived tables are maintained; and an executor module, configured to submit DML commands.

These and other aspects will become apparent from the following description of the invention taken in conjunction with the following drawings, although variations and modifications may be effected without departing from the spirit and scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary schematic of systems for providing metadata-aware background caching in a data analysis, in accordance with some embodiments of the present invention.

FIG. 2 illustrates an exemplary schematic of systems for providing metadata-aware background caching in a data analysis, in accordance with some embodiments of the present invention.

FIG. 3 depicts an exemplary schematic of systems for providing metadata-aware background caching, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

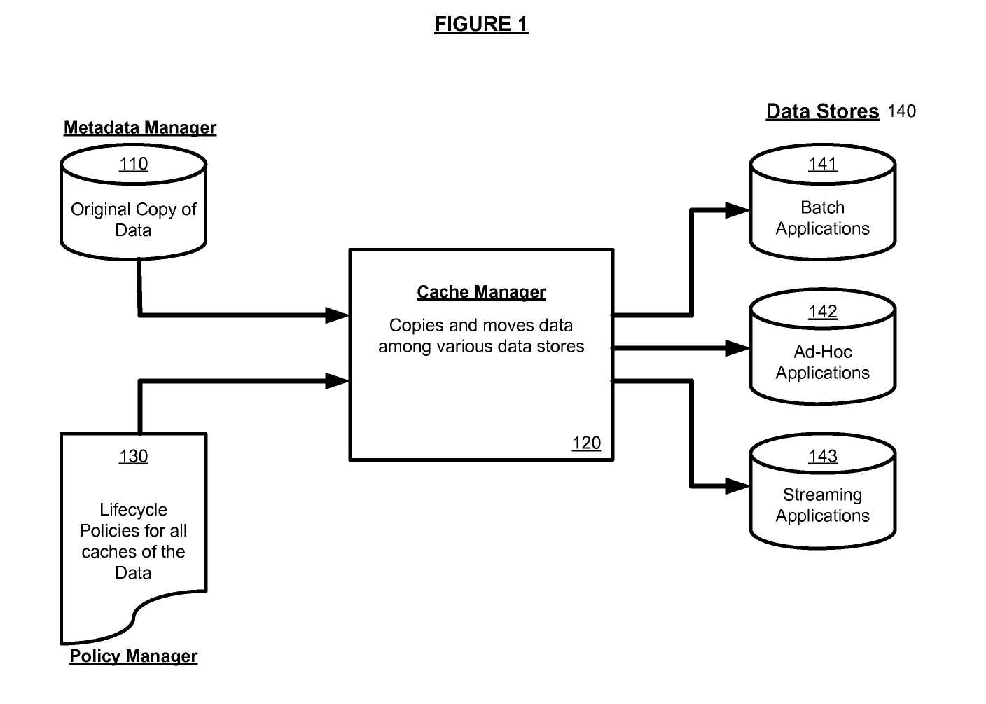

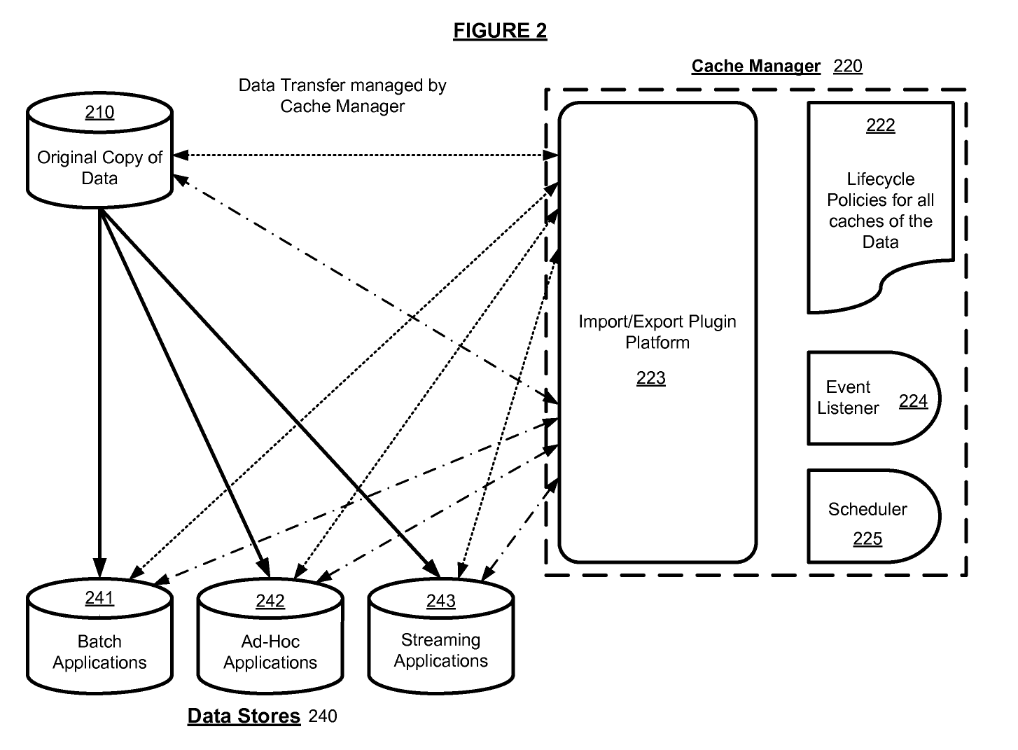

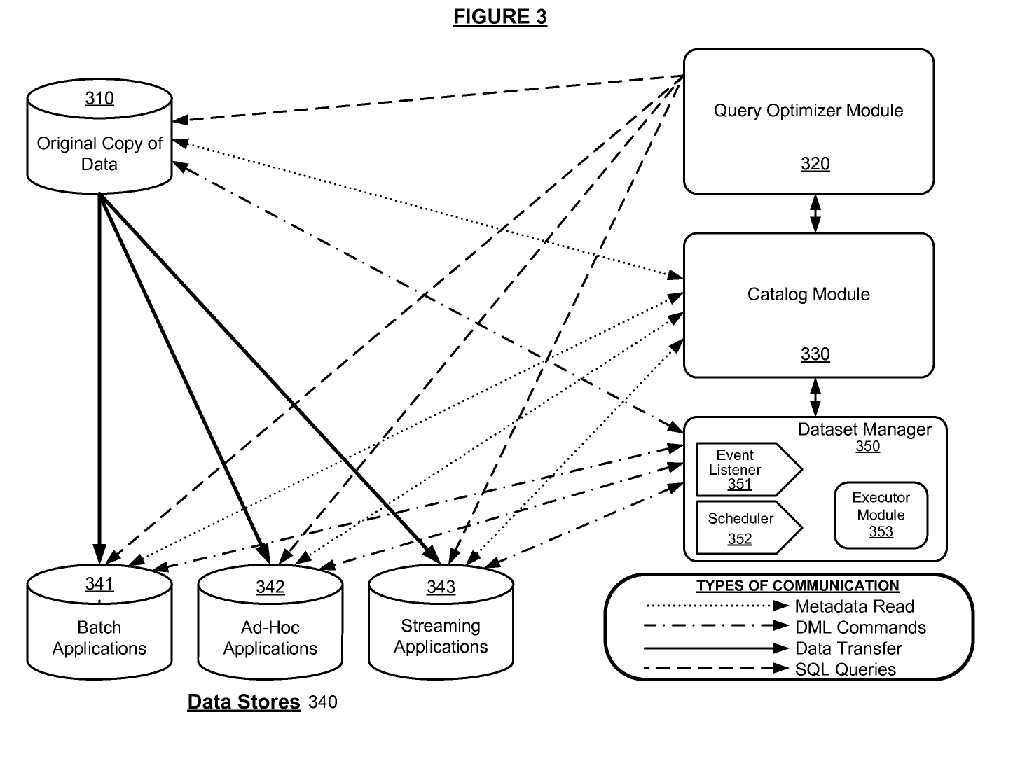

In general, the present invention is directed to systems and methods of creating and managing copies of data sets for data analysis across different data stores. As a broad overview, FIG. 1 below is generally directed to an exemplary workflow of a cache manager, in accordance with some embodiments of the present invention. FIG. 2 is generally directed to subsidiary modules that may be within the cache manager, in accordance with some embodiments of the present invention. FIG. 3 is generally directed to describing different modules and the interaction of such modules, in accordance with some embodiments of the present invention.

Note that various methods and techniques exist for managing indexes in a single database (e.g., index locking, concurrency control, etc.). However, such methods and techniques are only effective in a single, homogenous database. In contrast, the systems and methods in accordance with some embodiments of the present invention may create and manage copies of data sets across heterogeneous data stores and across different systems. Moreover, systems and methods in accordance with some embodiments of the present invention may store a master dataset as well as copies in data stores. Each data store may have common properties, such as: each data store may store metadata about the dataset; each data store may store the data of the dataset; each data store may include a mechanism for bulk export and import of datasets.

Systems and methods in accordance with some embodiments of the present invention may also provide functionality including, but not limited to, a plugin platform that may be able to understand and match metadata across data store technologies; a plugin platform that may be utilized to bulk export and import data into any data store technology; and/or a an operation to transfer data between data stores using the import/export plugin platform.

In addition, various database systems—as well as online analytical processing (OLAP) systems may use dataset features such as indexes, views, and cubes.

With reference to FIG. 1, in general, systems in accordance with the present invention may comprise a metadata manager (or a catalog) 110, a cache manager 120, a policy manager 130, and one or more data stores 140.

The metadata manager 110 may store metadata associated with the datasets. For example, the metadata manager 110 may store the structure of the original data (e.g., columns, data types, etc.), location, formats, and/or other sundry information about the dataset. Examples of a metadata manager may be the Metastore in Apache Hive, Apache HCatalog, or the Catalog module in Postgres.

The metadata manager 110 may, as discussed in greater detail below, generally comprise a catalog that may be utilized to register various tables across various data stores within an organization. For example, metadata manager 110 may have connectors to systems such as, but not limited to, Oracle, HBase, Hive, MySQL, etc., and may be enabled to pull data from tables in such systems. Metadata manager 110 may also perform metadata reads against the original copy of the data and the one or more data stores 140.

Moreover, metadata manager 110 may store relationships between various tables in various locations. Such relationships may be described as a view, cube, index, or other construct. A relationship between a table in Hive and a table in Redshift is discussed below with regard to FIG. 3.

The metadata manager 110 may provide such original copy of the data and details of the data set to the cache manager 120. The cache manager 120 may actually manage the copies of the data set, and move the data set among various data stores that may be present on various systems and in different formats. The cache manager 120 may communicate with the metadata manager 110 and be informed regarding events from the metadata manager 110. Upon any changes, the cache manager 120 may use the policy manager 130 as a guide to update a cache or index. Such updates may occur asynchronously. While an update to any cache or index of a data store is in progress, any requests to read the data may either (i) be redirected to the original data set (at the metadata manager 110), or (ii) return an exception that the data is not yet in the right format. Such exception may not be returned once an update is completed.

As noted above, the policy manager 130 may maintain a list of policies regarding a cache, such as data format, lifecycle of the cache (for example, maintain only the most recent thirty (30) days of data, etc.), location, etc. Policy manager 130 may be updated at any time, causing the cache manager 120 to modify the data stored amongst the data stores 140.

Data stores 140 may comprise one or more data stores that may be in any number of formats. For example, as shown in FIG. 1, data stores 140 may comprise a data set 141 used for batch applications, a data set 142 used for ad-hoc applications, and a data set 143 used for streaming applications. Each of these data stores 140 may be in different formats, and may reside on different systems.

Accordingly, utilizing systems and methods in accordance with some embodiments of the present invention, an organization may only be required to maintain a current data set at the metadata manager 110, and maintain policies regarding various caches or indexes that may be used in any of a number of different data stores and data formats. The cache manager 120 may perform the task of updating the various data stores, in each of their proper format, according to revisions made to the original data set and policies as updated at the policy manager 130. Therefore, the time, resources, and cost directed to managing various data sets related to the same set of data may be greatly reduced.

With reference to FIG. 2, a system and corresponding method in accordance with some embodiments of the present invention will now be discussed. In general, systems and methods may provide for data transfers from an original copy of data 210, managed by a cache manager 220, to various data stores 240. The cache manager 220 may comprise a policy manager 222, an import/export plugin platform 223, an event listener 224, and a scheduler 225.

In general, the cache manager 220 may accept plugins to read metadata from data stores. As a non-limiting example, cache manager 220 may comprise plugins to read metadata from the Metastore in Apache Hive, Apache HCatalog, and/or the Catalog module in Postgres. Typical metadata information may include the structure of the original data (for example, columns, data types, etc.), location, data formats, and other information about the datasets. Plugins may communicate with the event listener 224 in order to listen for events generated when the metadata may change.

Policy manager 222 may maintain a list of policies about a cache such as data format, lifecycle of the cache (for example, maintain only the most recent thirty (30) days of data, etc.), location, etc. The policy may be received and/or accepted from the user. The policy manager 222 may also redirect requests to find a specific dataset if such dataset is unavailable in a particular format to locations where such datasets are available.

The import/export plugin 223 may accept plugins that the cache manager 220 may submit import and export commands to the data store. In general, each data store 240 may include a method or mechanism to bulk import and/or export data. However, such methods or mechanisms are not standardized across the various data stores 241-243. Accordingly, the import/export plugin 223 may provide various plugins so that communications with each data store 241-243 in bulk import/export actions may be seen as more standardized by the cache manager.

The event listener 224 may listen to events from the original copy of the data 210 and use the policy manager 222 as a guide to initiate operations. For example, the event listener 224 may determine when new data is added, and may initiate an export followed by many imports. Similarly, the event listener 224 may determine when original data is deleted, and may initiate a delete data across one or more data stores. Event listener 224 may determine when data is modified, and initiate a modification of such data across one or more data stores.

Scheduler 225 may be used to periodically and regularly check policies and initiate operations. For example, if a catalog does not support listening to events through event listener 224, the scheduler 225 may schedule a periodic update or check for new data. Similarly, schedule 225 may be utilized to delete data if the age of such data exceeds policy requirements or if the window of data has expired.

With reference to FIG. 2, it can be seen that the original copy of data 210 may populate the data stores 240. The catalog may be in communication with the original copy of the data 210 (and any updates thereto) as well as to the data stores 240. Similarly, the import/export plugin platform 223 may be in communication with the original copy of the data 210 as well as the data stores 240. In this manner, changes and/or modifications to the data across any data store 240 or the original data 210 may be determined by the cache manager, and updated across data stores accordingly.

With reference to FIG. 3, a system 300 for metadata aware background caching in accordance with some embodiments of the present invention will now be discussed. In general, system 300 may be comprised of an original data copy 310, a query optimizer 320, a catalog 330, one or more data stores 340, and/or a dataset manager 350.

The original data copy 310 may be the data in its original format. This may be referred to as the canonical table. In general, the query optimizer 320 may be a pluggable module that may accept queries, refer to one or more catalogs, and determine upon which engine to run the query. The query optimizer may be in communication with catalog 330, as well as the original data source 310 and the one or more data stores 340. A executor may submit a command (for example, an SQL command) to a database (for example, an SQL database). For example, the query optimizer 320 may pass such information to a plugin executor for execution. Using the example described in Tables 1 and 2 below, a user may submit a query:

Select domain, view_date, sum(views) from

demotrends.pagecounts where view_date=‘2015-07-01’ and (domain =
‘fr’ or domain = ‘de’)

Group by view_date, domain
Order by view_date

In general, this query may refer to a table in Apache Hive—a table that is considered canonical in this example.

The query optimizer 320 may recognize that there is a table in Redshift (or a different location) that is related to the table in the query. Specifically, the query optimizer 320 may recognize that public.pc_part is related to demotrends.pagecounts. Moreover, the query optimizer 320 may perform an analysis to determine the most cost effective way to respond to a query. For example, the query optimizer 320 may determine that Redshift may run faster than Hive, and may be accordingly less expensive. Accordingly, the query optimizer 320 may use the derived table in Redshift may answer the query in place of the canonical table in Apache Hive.

If the query optimizer 320 is unable to run a query or processing request in derived tables—for example, if the data is outside the range of the definition—the query may be run in the canonical table (which may, for example, be stored in Apache Hive). For example:

Select sum(views), view_date, domain from

demotrends.pagecounts where view_date=‘2014-10-01’ and
(domain=‘fr’ or domain=‘de’)

Group by view_date, domain

The catalog 330 may, in general, store metadata associated with each of the datasets. For example, the catalog 330 may store the structure of the original data (e.g., columns, data types, etc.), location, formats, and/or other sundry information about the dataset. Examples of a catalog 330 may be the Metastore in Apache Hive, Apache HCatalog, or the Catalog module in Postgres. Moreover, catalog 330 may comprise a manager for registering all tables across all data stores within an organization. For example, catalog 330 may have connectors to systems such as, but not limited to, Oracle, HBase, Hive, MySQL, etc. The catalog 330 may be enabled to pull data from tables in such systems. As illustrated in FIG. 3, catalog 330 may be in communication with both query optimizer 320 and dataset manager 350. Catalog 330 may also perform metadata reads against the original data set 310 and the one or more data stores 341, 342, 343.

Catalog 330 may store the relationships between such various tables in various locations. Such relationships may be described as a view, cube, index, or other construct. For example, a view between a table in Hive and Redshift may be described as set forth in the tables below:

TABLE 1

| ID | Type | URL | User |
|---|---|---|---|
| 3 | HIVE | Jdbc:mysql://xxxx.yyyy.zzzmetastore | Hive_user |
| 4 | REDSHIFT | Jdbc:postgresql://aaa.bbb.ccc/testdb | root |

TABLE 2

| ID | Name | Canonical_ID | Derived_ID | Query | Table |
|---|---|---|---|---|---|
| 1 | Customer_partitions | 3 | 4 | Select domain, views, | PUBLIC.PC_PART |
| | | | | bytes_sent, view_date from | |
| | | | | demotrends.pagecounts where | |
| | | | | view_date > ‘2015-05-31’ and | |
| | | | | ((domain = ‘en’) or (domain = | |
| | | | | ‘fr’) or (domain = ‘ja’) or | |
| | | | | (domain = ‘de’) or (domain = | |
| | | | | ‘ru’)) | |

In the tables shown above, two SQL data stores (Hive and RedShift) have been registered with the catalog 330. These two tables are not related. The command ‘demotrends.pagecounts’ in Apache Hive is related to ‘public.pc_part’ in RedShift. This relationship may be described by SQL query in the query column. Note that this exemplary only, and the derived tables may be in any system, including Hive.

Data stores 340 may comprise one or more data stores that may be in any number of formats. For example, as shown in FIG. 3, data stores 340 may comprise a data set 341 used for batch applications, a data set 342 used for ad-hoc applications, and a data set 343 used for streaming applications. Each of these data stores 340 may be in different formats, and may reside on different systems.

Dataset manager 350 may manage the copies of the data set, and move the data set among various data stores that may be present on various systems and in different formats. The Dataset manager 350 may communicate with the catalog module 330 and be informed regarding events. Upon any changes, the dataset manager 350 may update a cache or index. Such updates may occur asynchronously. While an update to any cache or index of a data store is in progress, any requests to read the data may either (i) be redirected to the original data set or (ii) return an exception that the data is not yet in the right format. Such exception may not be returned once an update is completed.

In addition, dataset Manager 350 may be in communication with catalog 330, and may comprise modules, such as but not limited to an event listener module 351, a schedule module 352, and/or an executor module 353. In general, the dataset manager 350 may maintain the freshness of data stored in a derived dataset. The event listener module 351 may initiate a DML (data manipulation language) operation if the data store sends a notification. The scheduler module 352 may regularly or periodically check if policies are maintained, and may initiate a DML operation if required.

The example set forth above represents a static derivation of a canonical dataset. Below is an additional example:

Select domain, views, bytes_sent, view_date from

demotrends.pagecounts where view_date >($today − 90) and ((domain=
‘en’) or (domain=‘fr’) or (domain=‘ja’) or (domain=‘de’) or
(domain=‘ru’))

In the example above, it can be seen that query includes “($today—90)”. This parametrized query denotes that the derived table should store the last ninety (90) days of data. Accordingly, the dataset manager 350 may periodically and/or regularly check to determine that the relationship between the canonical and derived tables is maintained and current. The event listener module 351 may be activated or fired when or if data changes in the canonical table(s). The scheduler module 352 may similar check, as well as add or delete data.

Note that each data store may have a custom mechanism for bulk insert and deletion of data. Executor module 353 may refer to catalog 330 for relationships and policies, and may submit DML commands. The executor module 353 may be pluggable and may support any SQL data store.

With renewed reference to FIG. 3, communications (such as, but not limited to a transfer of information) as well as the type of communications between the various components illustrated in FIG. 3 will now be discussed.

In general, a direct data transfer may be conducted between the original data copy 310 and the one or more data stores 340. Query optimizer 320 may conduct an SQL query against both the original data copy 310 and each of the data stores 341, 342, 343. Catalog 330 may conduct a metadata read of each of the original data copy 310 and each of the data stores 341, 342, 343. Dataset manager 350 may conduct DML commands to the original data copy 310, and each of the one or more data stores 341, 342, 343.

It can be seen that each module accordingly conducts its own type of communications which are associated with the functionality of each module. The query optimizer 320 performs SQL queries against the canonical and derived data sources. The catalog 330 performs metadata reads against the canonical and derived data sources. The dataset manager issues and performs DML commands to the canonical and derived data sources.

In this manner, systems in accordance with some embodiments of the present invention may be utilized to perform processing functions across various data types at various locations.

It will be understood that the specific embodiments of the present invention shown and described herein are exemplary only. Numerous variations, changes, substitutions and equivalents will now occur to those skilled in the art without departing from the spirit and scope of the invention. Similarly, the specific shapes shown in the appended figures and discussed above may be varied without deviating from the functionality claimed in the present invention. Accordingly, it is intended that all subject matter described herein and shown in the accompanying drawings be regarded as illustrative only, and not in a limiting sense, and that the scope of the invention will be solely determined by the appended claims.

What is claimed is:

1. A system for providing metadata aware background caching amongst various tables in data processing systems, the system configured to process either an original copy of data stored in a first format or data stored in one or more derived tables in one or more data stores, the system comprising:
a query optimization module, the query optimization module communicatively connected to the original copy of data, the one or more derived tables, and a catalog module, the query optimization module configured to conduct queries against data stored in the original copy of data and/or in the one or more derived tables;
a catalog module, communicatively connected to the original copy of the data and the one or more derived tables, the catalog module in further communication with the query optimizer and a dataset manager, the catalog module configured to register tables of data across various types and formats of data stores;
a dataset manager, communicatively connected to the original copy of the data, the one or more derived tables, and the catalog module, the dataset manager configured to maintain the freshness of the data in the one or more derived tables.

2. The system of claim 1, wherein the query optimization module comprising a cost based optimizer that is configured to determine a most efficient and/or less costly manner of conducting queries, and performing queries in such determined manner.

3. The system of claim 1, wherein the catalog module performs metadata reads of each of the original copy of the data and the one or more derived tables.

4. The system of claim 3, wherein the catalog module performs such metadata reads periodically, or when triggered by a query or other processing request.

5. The system of claim 1, wherein the dataset manager comprises:
an event listener module, the event listener module configured to initiate a data manipulation language (DML) operation when prompted;
a scheduler module, configured to regularly and/or periodically check if policies associated with the original copy of the data and the one or more derived tables are maintained; and
an executor module, configured to submit DML commands.

6. The system of claim 1, wherein the original copy of the data is submitted to the one or more derived tables via a data transfer.

7. The system of claim 1, wherein the one or more derived tables may comprise data stores used by batch applications, ad hoc applications, or streaming data.

8. A system for providing metadata aware background caching amongst various tables in data processing systems, the system configured to process an original copy of data stored in a first format and/or data stored in one or more derived tables in one or more data stores, the system comprising:
a cache manager, configured to copy and move data amongst various data stores, the cache manager in selective communication with the original copy of data, one or more data stores in which the one or more derived tables are stored, and/or a policy manager module;
a policy manager module in communication with the cache manager, the policy manager comprising lifecycle policies for the original copy of data and the one or more data stores; and
one or more data stores, comprising one or more derived tables that comprise data derived from the original copy of the data.

9. The system of claim 8, wherein the one or more data stores comprise data stores used by batch applications, ad hoc applications, or streaming data.

10. The system of claim 8, wherein the cache manager performs data transfers between and amongst the original copy of data and the one or more derived tables in the one or more data stores.

11. A system for providing metadata aware background caching amongst various tables in data processing systems, the system configured to process either an original copy of data stored in a first format or data stored in one or more derived tables in one or more data stores, the system comprising:
a query optimization module comprising a cost-based optimizer configured to determine a most desirable manner of conducting queries, and further configured to conduct queries against data stored in the original copy of data and/or in the one or more derived tables;
a catalog module configured to perform metadata reads of each of the original copy of the data and the one or more derived tables, and further configured to register tables of data across various types and formats of data stores;
a dataset manager configured to maintain the freshness of the data in the one or more derived tables, the data set manager comprising:
an event listener module, the event listener module configured to initiate a data manipulation language (DML) operation when prompted;
a scheduler module, configured to regularly and/or periodically check if policies associated with the original copy of the data and the one or more derived tables are maintained; and
an executor module, configured to submit DML commands.

12. The system of claim 11, wherein the query optimization module is communicatively connected to the original copy of data, the one or more derived tables, and a catalog module to conduct structured query language (SQL) queries.

13. The system of claim 11, wherein the catalog module is communicatively connected to the original copy of the data, the one or more derived tables, the query optimizer, and a dataset manager, the catalog manager configured to perform metadata reads on the original copy of the data and the one or more derived tables.

14. The system of claim 11, wherein the dataset manager is communicatively connected to the original copy of the data, the one or more derived tables, and the catalog module, and is configured to submit DML commands to the original copy of the data and/or the one or more derived tables.

15. The system of claim 11, wherein the one or more derived tables may comprise data stores used by batch applications, ad hoc applications, or streaming data.
